(19) United States
(12) Patent Application Publication
(10) Pub. No.: US 2013/0173937 A1
(43) Pub. Date: Jul. 4, 2013

(54) EXPANDABLE ETHERNET POWER SUPPLY DEVICE

(71) Applicant: Chien-Chung LEE, New Taipei City (TW)

(72) Inventor: Chien-Chung LEE, New Taipei City (TW)

(73) Assignee: CABLE VISION ELECTRONICS CO., LTD.

(21) Appl. No.: 13/656,746

(22) Filed: Oct. 22, 2012

(30) Foreign Application Priority Data
Dec. 29, 2011 (TW) 100224878

(51) Int. Cl. G06F 1/26

(52) U.S. Cl. 713/300

(57) ABSTRACT

An expandable Ethernet power supply device includes a network line, a power sourcing equipment (PSE), a DC power inputting terminal and a power outputting terminal. A PoE outputting port is inserted into network equipment. An Ethernet connector is connected to a network data source. A DC power is inputted to the DC power inputting terminal and managed by the PSE, and then providing demanded working voltage of the network equipment and transmitting network data. The power outputting terminal is provided for connecting to the DC power inputting terminal of another Ethernet power supply device and demanded working voltage of more network equipment.

This application is based on and claims the benefit of Taiwan Application No. 100224878 filed Dec. 29, 2011 the entire disclosure of which is incorporated by reference herein.

### BACKGROUND OF THE INVENTION

1. Field of the Invention

The present invention relates to a power supplying of Ethernet, and in particular to power supply device of Ethernet.

2. Description of Prior Art

A conventional Ethernet power supply device 100 (as shown in FIG. 1) for providing power to network equipment without Ethernet power supply includes a power inputting terminal 101, an Ethernet power supply connecting port 102 and an Ethernet connecting port 103. For instance, when an old network switch is collocated with a wireless station or hub, owing to the network switch cannot provide power, the network switch must be connecting to the Ethernet connecting port 103, and then connected the Ethernet power supply connecting port 102 and the wireless station or hub. When an alternating-current (AC) power is inputted to the power inputting terminal 101, an AC to direct-current (DC) power converter disposed within the Ethernet power supply device 100 converts the AC power into DC power, and then a demanded power is outputted to the wireless station or hub via the Ethernet power supply connecting port 102. Network data transmitted by the network switch is inputted to the Ethernet connecting port 103 at the same time, and transmitted to the wireless station or hub via the Ethernet power supply connecting port 102.

Because the AC to DC converter is integrated into the conventional Ethernet power supply device 100, the volume of the Ethernet power supply device 100 is bulky. Besides, shelf for disposing network switches disposes multiple network switches in general, such that network sockets of each network switch must be connected to an Ethernet power supply device 100, and shelf for disposing server cannot contain large numbers of Ethernet power supply devices 100, this will increase difficulty of connection and building.

### SUMMARY OF THE INVENTION

It is an object to provide an expandable Ethernet power supply device, which separates AC to DC converter from Ethernet power supply device and has miniature volume for solving problems of conventional Ethernet power supply device.

It is another object to provide miniaturized Ethernet power supply devices, which can be installed on a mezzanine of shelf for disposing network switch which is located between where the network switches or any aperture of the shelf for disposing the network switch.

Accordingly, the expandable Ethernet power supply device includes an Ethernet connector, a PoE outputting port, a power sourcing equipment (PSE), a DC power inputting terminal and a power outputting terminal. The PoE outputting port is electrically connected to the Ethernet connector, the PSE is electrically connected to the PoE outputting port, the DC power inputting terminal is electrically connected to the PSE, and the power outputting terminal is electrically connected to the DC power inputting terminal.

Accordingly, the expandable Ethernet power supply device includes a housing, a power sourcing equipment (PSE), an PoE outputting port, a cable, a DC power inputting connector and a power outputting connector. The PSE is disposed within the housing, the PoE outputting port is disposed on one end of the housing electrically connected to the PSE, the cable is disposed on the other end of the housing and electrically connected to the PoE outputting port, and the other end of the cable has an Ethernet connector. The DC power inputting connector is electrically connected to the PSE, and the power outputting connector is electrically connected to the DC power inputting connector.

### BRIEF DESCRIPTION OF DRAWING

The features of the invention believed to be novel are set forth with particularity in the appended claims. The invention itself however may be best understood by reference to the following detailed description of the invention, which describes certain exemplary embodiments of the invention, taken in conjunction with the accompanying drawings in which:

FIG. 1 is a schematic view of a conventional Ethernet power supply device.

FIG. 2 is a circuit diagram of an Ethernet power supply device according to a first embodiment of the present invention.

FIG. 3 is a schematic view of the Ethernet power supply device according to the first embodiment of the present invention.

FIG. 4A and FIG. 4B are schematic views showing usage state of the Ethernet power supply device in FIG. 3.

FIG. 5 is circuit diagram of an Ethernet power supply device according to a second embodiment of the present invention.

FIG. 6 is an Ethernet power supply device according to a third embodiment of the present invention.

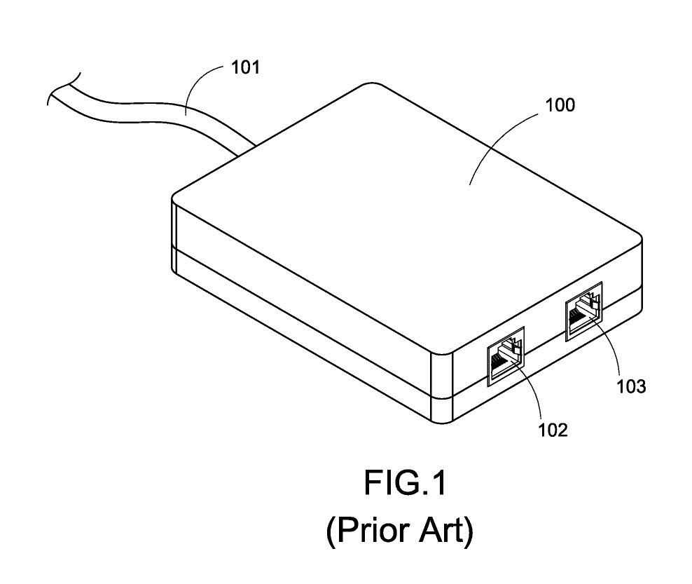

### DETAILED DESCRIPTION OF THE INVENTION

A preferred embodiment of the present invention will be described with reference to the drawings.

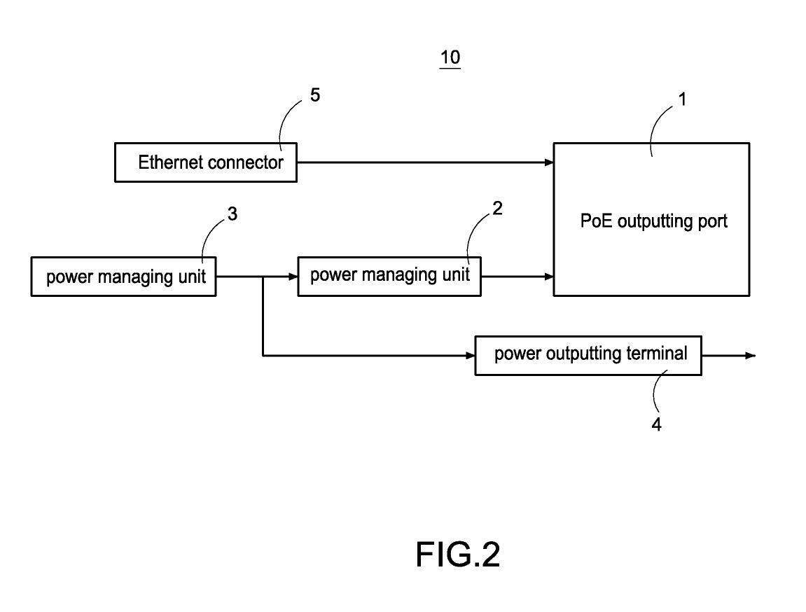

Reference is made to FIG. 2, which is a circuit diagram of an Ethernet power supply device according to a first embodiment of the present invention. The Ethernet power supply device 10 includes a power over Ethernet (PoE) outputting port 1, a power sourcing equipment (PSE) 2, a direct-current (DC) power inputting terminal 3, a power outputting terminal 4, and an Ethernet connector 5. The Ethernet connector 5 (being an inputting terminal of Ethernet) is inserted into a network socket or network equipment (such as modem, network switch) and electrically connected to the PoE outputting port 1 for transmitting network data. An external DC power inputted to the DC power inputting terminal 3 is managed by the PSE 2 and then transmitted to the PoE outputting port 1 for providing power to the network equipment connected to the PoE outputting port 1. The DC power is also directly transmitted to the power outputting terminal 4 for providing power to network equipment (such as internet phone, wireless access station, webcam, hub, computer etc.) or another Ethernet power supply device.

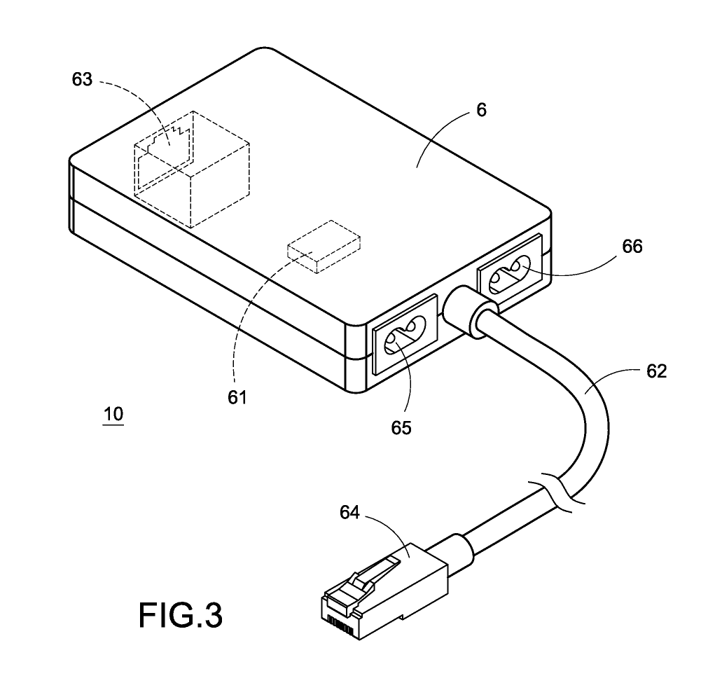

Reference is made to FIG. 3, which is a schematic view of the Ethernet power supply device according to the first embodiment of the present invention. The Ethernet power supply device 10 has a housing 6. A PSE 61 is disposed within the housing 6. One end of the housing 6 has a cable 62. One end of the cable 62 is electrically connected to a PoE outputting port 63, and the other end of the cable 62 has an Ethernet connector (for inputting Ethernet), which is an RJ45 male connector. A front end of the housing 6 includes a DC power inputting connector 65 and a power outputting connector 66. The DC power inputting connector 65 electrically connected to the power outputting connector 66 and the PSE 61, respectively. The other end of the housing 6 has a PoE outputting port 63, and the PoE outputting port 61 is electrically connected to the PSE 61. The PoE outputting port 63 is an RJ45 female connector for a network line with RJ45 male connector inserting therein.

When used, the Ethernet connector 64 is inserted into the network equipment (such as network switch), the PoE outputting port 63 is used for inserting the network line of the network equipment. A power source provided by an external alternating-current (AC) to DC converter (not shown) is inputted to the DC power inputting connector 65 and managed by the PSE 61, and then the managed power source provides a working voltage to the network equipment by the PoE outputting port 63. In addition, the DC power inputted by the DC power inputting connector 65 is outputted by the power outputting connector 66, and then the power outputting connector 66 transmits power to another Ethernet power supply device 10 or other network equipment.

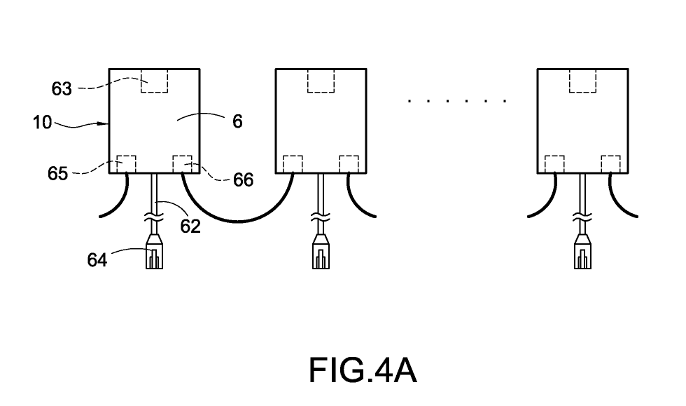

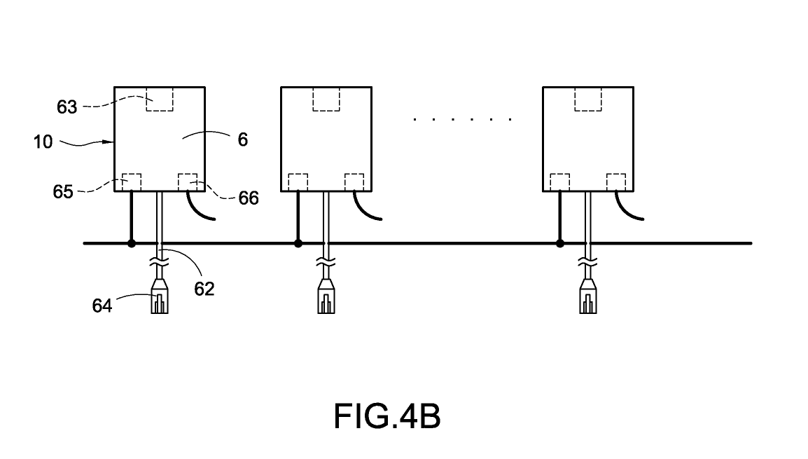

Reference is made to FIG. 4A and FIG. 4B, which are schematic views showing usage state of the Ethernet power supply device in FIG. 3. When using the Ethernet power supply devices 10 mentioned above, the power outputting connector 66 of a first Ethernet power supply device 10 is connected to the DC power inputting connector 65 of a second Ethernet power supply device 10, thus a DC power inputted to the DC inputting connector of the first Ethernet power supply device 10 is transmitted to each Ethernet power supply device 10, and the Ethernet power supply device are electrically connected in series.

However, the DC power inputting connector 65 of a first Ethernet power supply device 10 can be connected to the DC power inputting connector 65 of a second Ethernet power supply 10, and the DC power inputting connectors 65 of the first and second Ethernet power supply devices 10 are electrically connected to an external AC to DC converter (or power supply), such that power provided by the AC to DC converter (or power supply) is transmitted to each Ethernet power supply device 10, and the Ethernet power supply devices 10 are electrically connected in parallel.

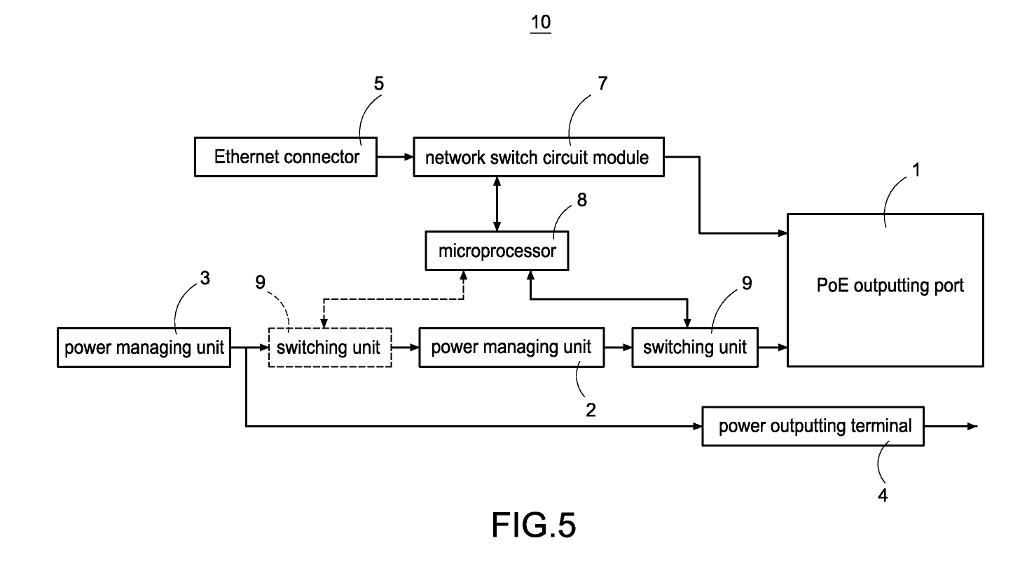

Reference is made to FIG. 5, which is a circuit diagram of Ethernet power supply device according to a second embodiment of the present invention. A network switch circuit module is electrically connected between the PoE outputting port 1 and the Ethernet connector 5 of the Ethernet power supply device 10. The network switch circuit module 7 is also electrically connected to a microprocessor 8. The microprocessor 8 is electrically connected to a switching unit 9. The switching unit 9 is electrically connected between the PoE outputting port 1 and the PSE 2. However, the switching unit 9 can also be electrically connected between the DC power inputting terminal 3 (or the DC power outputting connector 65) and the PSE 2, and is electrically connected to the microprocessor 8. In this embodiment, the switching unit 9 is, for example, a relay.

The Ethernet power supply device 10 can be controlled by equipment such as computer when it is completely connected, and controlling commend is transmitted to the network switch circuit module 7 via network connection, and then transmitted to the microprocessor 8 by the network switch circuit module 7. The microprocessor 8 controls the switching unit 9 to turn on for supplying power or to turn off for stopping supplying power.

Furthermore, the switching unit 9 can be disposed within the PSE 2.

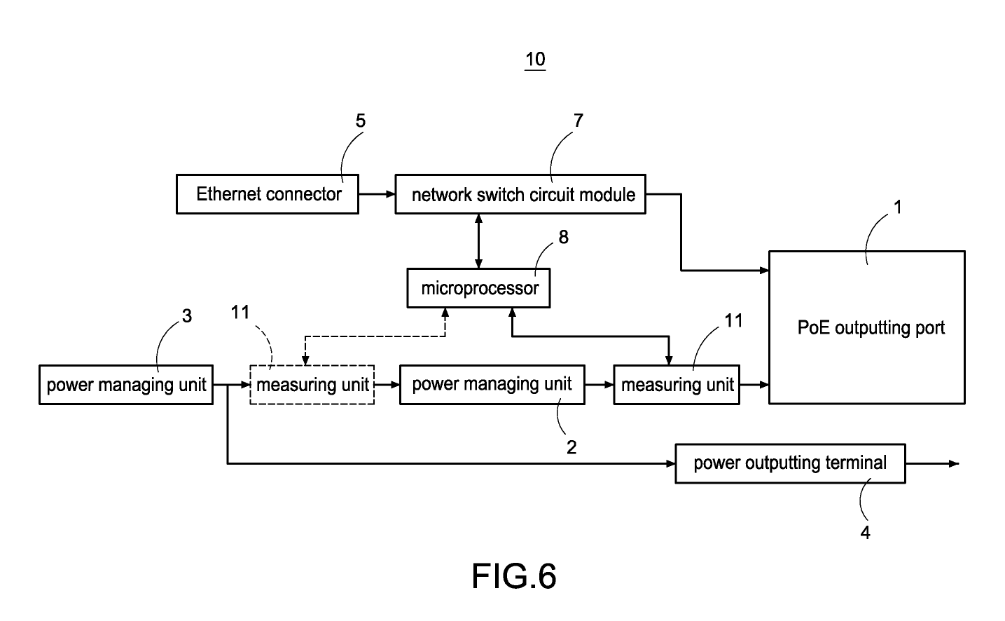

Reference is made to FIG. 6, which is a circuit diagram of according to a third embodiment of the present invention. A network switch circuit module 7 is electrically connected between the PoE outputting port 1 and the Ethernet connector 5 of the Ethernet power supply device 10. The network switch circuit module 7 is also electrically connected to a microprocessor 8. The microprocessor 8 is electrically connected a measuring unit 11. The measuring unit 11 is electrically connected between the PoE outputting port 1 and the PSE 2. However, the measuring unit 11 may be electrically connected between the DC power inputting terminal 3 (or DC power inputting connector 65) and the PSE 2, and is electrically connected to the microprocessor 8. In this embodiment, the measuring unit 11 for measuring power of the Ethernet power supply device 10 needs two parameters, namely, voltage and current. Current measurement is indispensable. However, voltage measurement is dispensable because the voltage may be given.

The measuring unit 11 is a power measuring circuit. After the measuring unit 11 measures voltage and current, the results is transmitted to the microprocessor 8, and then passed to equipment (such as computer). The value of power may be computed by the microprocessor 8 or computer.

Although the present invention has been described with reference to the foregoing preferred embodiment, it will be understood that the invention is not limited to the details thereof. Various equivalent variations and modifications can still occur to those skilled in this art in view of the teachings of the present invention. Thus, all such variations and equivalent modifications are also embraced within the scope of the invention as defined in the appended claims.

What is claimed is:

1. An expandable Ethernet power supply device connecting to and supplying power to network equipment, the expandable Ethernet power supply device comprising:
an Ethernet connector;
a power over Ethernet (PoE) outputting port connected to the Ethernet connector;
a power source equipment (PSE) electrically connected to the PoE outputting port;
a direct-current (DC) power inputting terminal electrically connected to the PSE; and
a power outputting terminal electrically connected to the DC power inputting terminal.

2. The expandable Ethernet power supply device in claim 1, wherein the power outputting terminal of a first Ethernet power supply device is connected to the DC power inputting power terminal of a second Ethernet power supply device, such that a DC power inputted by the DC power inputting terminal of the first Ethernet power supply terminal is transmitted to each Ethernet power supply device, and the Ethernet power supply devices are electrically connected in series.

3. The expandable Ethernet power supply device in claim 2, wherein a network switch circuit module is electrically connected between the PoE outputting port and the Ethernet connector, the network switch circuit module is electrically connected to a microprocessor, the microprocessor is electrically connected to a switching unit, the switching unit is electrically connected between the PSE and the PoE outputting port or the DC power inputting terminal for controlling status of power.

4. The expandable Ethernet power supply device in claim 3, wherein the switching unit is disposed within the PSE.

5. The expandable Ethernet power supply device in claim 2, wherein a network switch circuit module is electrically connected between the PoE outputting port and the Ethernet connector, the network switch circuit module is electrically connected to a microprocessor, the microprocessor is electrically connected to a measuring unit, the measuring unit is electrically connected between the PSE and the PoE outputting port or the DC power inputting terminal for measuring outputting power of the Ethernet power supply device.

6. The expandable Ethernet power supply device in claim 1, wherein the DC power inputting terminal of a first Ethernet power supply device is connected to the DC power inputting terminal of a second Ethernet power supply device, and the DC power inputting terminals of the first and second Ethernet power supply device are electrically connected to an external alternating (AC) to DC power supply or a converter, such that power provided power the external AC to DC power supply or the converter is transmitted to each Ethernet power supply device, and the Ethernet power supply devices are electrically connected in parallel.

7. The expandable Ethernet power supply device in claim in claim 6, wherein a network switch circuit module is electrically connected between the PoE outputting port and the Ethernet connector, the network switch circuit module is electrically connected to a microprocessor, the microprocessor is electrically connected to a switching unit, the switching unit is electrically connected between the PSE and the PoE outputting port or the DC power inputting terminal for controlling the status of power.

8. The expandable Ethernet power supply device in claim in claim 7, wherein the switching unit is disposed within the PSE.

9. The expandable Ethernet power supply device in claim in claim 6, wherein a network switch circuit module is connected between the PoE outputting port and the Ethernet connector, the network switch circuit module is connected to a microprocessor, the microprocessor is electrically connected to a measuring unit, the measuring is electrically connected between the PSE and the PoE outputting port or the DC power inputting terminal for measuring output power of the Ethernet power supply device.

10. An expandable Ethernet power supply device connecting to and supplying power to network equipment, the expandable Ethernet power supply device comprising:
a housing:
a power sourcing equipment (PSE) disposed within the housing;
a PoE outputting port disposed at one end of the housing and electrically connected to the PSE;
a cable, one end of the cable disposed on the other end of the housing are electrically connected to the PoE outputting port, and the other end of the cable having an Ethernet connector;
a DC power inputting connector electrically connected to the PSE; and
a power outputting connector electrically connected to the DC power inputting connector.

11. The expandable Ethernet power supply device in claim in claim 10, wherein the power outputting connector of a first Ethernet power supply device is connected to the DC power inputting connector of a second Ethernet power supply device, such that a DC power inputted by the DC power inputting connector of the first Ethernet power supply device is transmitted to each Ethernet power supply device, and the Ethernet power supply devices are electrically connected in series.

12. The expandable Ethernet power supply device in claim in claim 10, wherein the DC power inputting connector of a first Ethernet power supply device is connected to the DC power inputting connector of a second Ethernet power supple device, and the DC power inputting connectors of the first and second Ethernet power supply device are connected to an external AC to DC power supply or converter, such that power provided by the AC to DC power supply or converter is transmitted to each Ethernet power supply device, and the Ethernet power supply devices are electrically connected in parallel.
